(19) United States
(12) Patent Application Publication
(10) Pub. No.: US 2009/0015552 A1
(43) Pub. Date: Jan. 15, 2009

(54) Operation system, pointing device for 3-dimensional operations, and operation method

(75) Inventors: Kenichi Kawasaki, Tokyo (JP); Masayuki Tanaka, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/156,246

(22) Filed: May 30, 2008

(30) Foreign Application Priority Data
Jul. 9, 2007 (JP) P2007-179560

(51) Int. Cl. G06F 3/033

(52) U.S. Cl. 345/157

(57) ABSTRACT

An operation system used for operating a pointer on a display screen includes a first transmitting section, a first receiving section, a measuring section, and an outputting section. The first transmitting section transmits radio waves of a millimeter band. The first receiving section receives the radio waves transmitted from the first transmitting section, a distance between the first transmitting section and the first receiving section being changeable. The measuring section measures an amplitude of the radio waves received by the first receiving section. The outputting section outputs an operation signal for executing an operation of the pointer on the display screen in a depth direction in accordance with a change of the amplitude of the radio waves measured by the measuring section.

### CROSS REFERENCES TO RELATED APPLICATIONS

The present invention contains subject matter related to Japanese Patent Application JP 2007-179560 filed in the Japanese Patent Office on Jul. 9, 2007, the entire contents of which being incorporated herein by reference.

### BACKGROUND OF THE INVENTION

1. Field of the Invention

The present invention relates to an operation system for operating a pointer on a display screen using a pointing device for 3-dimensional operations, for example, a pointing device for 3-dimensional operations used in the operation system of this type, and an operation method therefor.

2. Description of the Related Art

Use of pointing devices for 3-dimensional operations as input apparatuses for operating GUIs (Graphical User Interfaces) in computers, game machines, and household electrical appliances requires no desks in operating the pointing devices. In addition, since the pointing devices for 3-dimensional operations are operated 3-dimensionally, not only operations on XY coordinates on a display screen, but also operations on the screen in a depth direction (Z coordinate) are made possible, thus enabling intuitional operations.

In related art, for positional detection in the depth direction as described above, Japanese Patent Application Laid-open No. 05-127809 (FIG. 6) (hereinafter, referred to as Patent Document 1) proposes a technique in which light reflected from a device held by a user is received at two points, and a distance between a main body and the device is obtained by means of trigonometry.

### SUMMARY OF THE INVENTION

The technique disclosed in Patent Document 1 requires a light emitting section and a light receiving section at two points, which complicates a system structure.

In view of the above-mentioned circumstances, there is a need for an operation system, a pointing device for 3-dimensional operations, and an operation method that are capable of operating a pointer on a display screen in a depth direction with an extremely simple structure.

According to an embodiment of the present invention, there is provided an operation system used for operating a pointer on a display screen, including a first transmitting section, a first receiving section, a measuring section, and an outputting section. The first transmitting section transmits radio waves of a millimeter band. The first receiving section receives the radio waves transmitted from the first transmitting section, a distance between the first transmitting section and the first receiving section being changeable. The measuring section measures an amplitude of the radio waves received by the first receiving section. The outputting section outputs an operation signal for executing an operation of the pointer on the display screen in a depth direction in accordance with a change of the amplitude of the radio waves measured by the measuring section.

Here, the millimeter band refers to a band with a frequency of 30 GHz to 300 GHz (wavelength of about 10 mm to 1 mm).

Radio devices in related art have used radio waves having a frequency with a relatively long wavelength and with less free space propagation loss (radio waves of a band longer in wavelength than the millimeter band). However, the radio waves having a relatively long wavelength as described above are not fit for measuring distances at radio field intensity due to its long wavelength since it complicates specification of a center position of an antenna. Another reason that the radio waves having a relatively long wavelength as described above are not fit for measuring distances at radio field intensity is that small free space propagation loss causes a large amount of reflection indoors, and standing waves are thus easily generated. The radio waves of the millimeter band on the other hand bear no disadvantage as the radio waves having a relatively long wavelength as described above, but a device is enlarged and is accordingly poor in practicality.

However, in recent years, due to an increase in speed of CMOS (Complementary Metal Oxide Semiconductor) devices, millimeter-wave circuits have become capable of being realized in the inexpensive CMOS devices. The inventors of the present invention have focused on this point and found that a movement amount and a movement direction in the depth direction can be detected by use of the radio waves of the millimeter band brought into practical use. Specifically, in the embodiment of the present invention, an amplitude of the radio waves corresponding to the distance between the first transmitting section configured to transmit the radio waves of the millimeter band and the first receiving section configured to receive the radio waves is measured to thus realize an operation of the pointer on the display screen in the depth direction in accordance with a change in amplitude of the radio waves. In the embodiment of the present invention, because the system can be constituted by a single transmitting section and a single receiving section, an operation of the pointer on the display screen in the depth direction is made possible with an extremely simple structure. In addition, an operation that matches an intuitional operation of a user becomes possible since the pointer on the display screen is operated in the depth direction according to the distance between the first transmitting section configured to transmit the radio waves of the millimeter band and the first receiving section configured to receive the radio waves (operation of a user in the depth direction).

According to the embodiment of the present invention, the operation system may include a first apparatus having a display device configured to display the display screen and a second apparatus as a pointing device for 3-dimensional operations for the first apparatus. In the operation system, the first apparatus includes the first transmitting section, a second receiving section configured to receive an information signal transmitted from the second apparatus, and the outputting section. The second apparatus includes the first receiving section, the measuring section, an information generating section configured to generate information corresponding to the change of the amplitude of the radio waves measured by the measuring section, and a second transmitting section configured to transmit an information signal containing information generated by the information generating section.

In this case, the operation system may be structured such that the information generating section compares data on the amplitude of the radio waves measured by the measuring section stored in a memory, which is configured to store pieces of data on amplitudes of radio waves measured by the measuring section, with data previously stored in the memory, and generates the information containing a movement direction and a movement amount of the pointer on the display screen in the depth direction based on a result of the comparison.

Further, the operation system may be structured such that the second apparatus includes a user interface section to which information for operating the pointer on the display screen in X-Y directions is input, the second transmitting section incorporates information input by the user interface section into the information signal and transmits the information signal thereafter, and the outputting section outputs as the operation signal a signal for executing the operation of the pointer on the display screen in the X-Y directions in accordance with the information input by the user interface section and contained in the information signal.

Moreover, the operation system may be structured such that transmission/reception of the information signal is carried out by use of infrared rays between the second transmitting section and the second receiving section.

Furthermore, the operation system may be structured such that transmission/reception of the information signal is carried out by use of the radio waves of the millimeter band between the second transmitting section and the second receiving section.

As another example, the operation system may include a first apparatus having a display device configured to display the display screen and a second apparatus as a pointing device for 3-dimensional operations for the first apparatus. In the operation system, the first apparatus includes the first receiving section, the measuring section, and the outputting section. The second apparatus includes the first transmitting section.

According to another embodiment of the present invention, there is provided a pointing device for 3-dimensional operations used for operating a pointer on a display screen, including a receiving section, a measuring section, an information generating section, and a transmitting section. The receiving section receives radio waves of a millimeter band. The measuring section measures an amplitude of the radio waves received by the receiving section. The information generating section generates information for executing an operation of the pointer on the display screen in a depth direction in accordance with a change of the amplitude of the radio waves measured by the measuring section. The transmitting section transmits an information signal containing information generated by the information generating section.

According to another embodiment of the present invention, there is provided a method of operating a pointer on a display screen, including: transmitting radio waves of a millimeter band; receiving the transmitted radio waves at a second position different from a first position at which the radio waves of the millimeter band are transmitted, a distance between the first position and the second position being changeable; measuring an amplitude of the received radio waves; and executing an operation of the pointer on the display screen in a depth direction in accordance with a change of the measured amplitude of the radio waves.

As described above, according to the embodiments of the present invention, operations of the pointer on the display screen in the depth direction are made possible with an extremely simple structure.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing a structure of an operation system according to an embodiment of the present invention;

FIG. 2 is a flowchart showing an operation carried out when a pointer is operated on a display screen in a depth direction;

FIG. 3 is a diagram showing a state where a door displayed on the display screen is pressed by a pointing device for 3-dimensional operations;

FIG. 4 is a diagram showing a state where the door displayed on the display screen is pulled by the pointing device for 3-dimensional operations;

FIG. 5 is a diagram showing a state where the pointer is moved to a different plane on the display screen by the pointing device for 3-dimensional operations;

FIG. 6 is a diagram showing a state where the pointer is moved to a different plane on the display screen by the pointing device for 3-dimensional operations;

FIG. 7 is a diagram illustrating a relationship between a free space propagation loss and an inter-apparatus distance;

FIG. 8 is a diagram illustrating a problem of a low frequency in related art;

FIG. 9 is a setup diagram when actually conducting a propagation experiment at a millimeter wave (60 GHz);

FIG. 10 shows a result of the experiment shown in FIG. 9;

FIG. 11 shows a result of a simulation conducted to confirm how close transmission/reception antennae can be brought to each other;

FIG. 12 is a block diagram showing a structure of the operation system when transmission of an information signal returned from the pointing device for 3-dimensional operations is carried out using millimeter waves instead of infrared rays; and

FIG. 13 is a block diagram showing a structure of the operation system when transmitting the millimeter waves from the pointing device for 3-dimensional operations side (transmission of a reference signal).

### DESCRIPTION OF PREFERRED EMBODIMENTS

Hereinafter, embodiments of the present invention will be described with reference to the drawings.

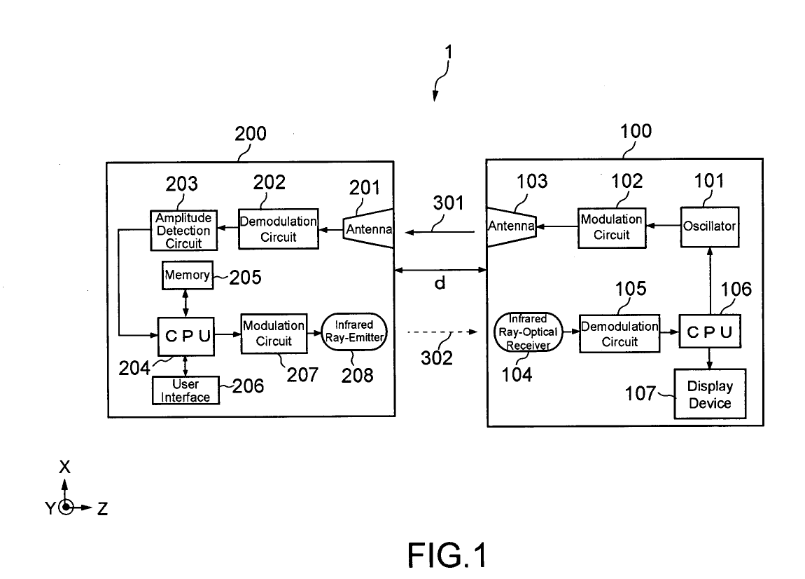

FIG. 1 is a block diagram showing a structure of an operation system according to an embodiment of the present invention.

As shown in FIG. 1, an operation system 1 includes an information processing apparatus 100 and a pointing device for 3-dimensional operations 200 as an input apparatus (e.g., mouse for 3-dimensional operations) for the information processing apparatus 100.

The information processing apparatus 100 includes an oscillator 101, a modulation circuit 102, an antenna 103, an infrared ray-optical receiver 104, a demodulation circuit 105, a CPU (Central Processing Unit) 106, and a display device 107.

The oscillator 101 generates a signal of a millimeter band of 30 GHz to 300 GHz, for example, and transmits the signal to the modulation circuit 102. The oscillator 101 realizes a millimeter-wave circuit by an inexpensive CMOS device, for example. The modulation circuit 102 modulates the signal of the millimeter band transmitted from the oscillator 101. The antenna 103 transmits a signal wave obtained by the modulation of the modulation circuit 102.

The infrared ray-optical receiver 104 receives infrared rays emitted from an infrared ray-emitter 208 to be described later, and transmits an information signal thereof to the demodulation circuit 105. The demodulation circuit 105 demodulates the information signal from the infrared ray-optical receiver 104 and transmits the demodulated signal to the CPU 106. The demodulated information signal contains information on a movement direction and a movement amount of a pointer on a display screen of the display device 107 in a depth direction.

The CPU 106 outputs to the display device 107 an operation signal for executing an operation of the pointer on the display screen in the depth direction in accordance with a change in the demodulated information signal, or outputs to the display device 107 an operation signal for executing an operation of the pointer on the display screen in X-Y directions in accordance with information input by a user interface 206 and contained in the information signal. The display device 107 displays the pointer at, for example, an appropriate position on the display screen in response to the signal output from the CPU 106. In FIG. 1, the display screen is disposed within an X-Y plane, for example.

The pointing device for 3-dimensional operations 200 includes an antenna 201, a demodulation circuit 202, an amplitude detection circuit 203, a CPU 204, a memory 205, the user interface 206, a modulation circuit 207, and the infrared ray-emitter 208, a distance between the pointing device for 3-dimensional operations 200 and the information processing apparatus 1 being changeable.

The antenna 201 receives the radio waves of the millimeter band transmitted from the antenna 103. The demodulation circuit 202 demodulates the signal from the antenna 201 and transmits the demodulated signal to the amplitude detection circuit 203. The amplitude detection circuit 203 measures an amplitude of the signal demodulated by the demodulation circuit 202 and transmits the signal to the CPU 204.

The CPU 204 detects the amplitude of the received signal of the millimeter band every time a predetermined time passes, and compares the amplitude with amplitude data previously stored in the memory 205 to thus obtain a differential therebetween. Consequently, the CPU 204 calculates the movement direction of the pointer on the display screen in the depth direction (Z-axis direction) and the movement amount thereof in the Z-axis direction.

The memory 205 stores values of amplitudes measured by the amplitude detection circuit 203.

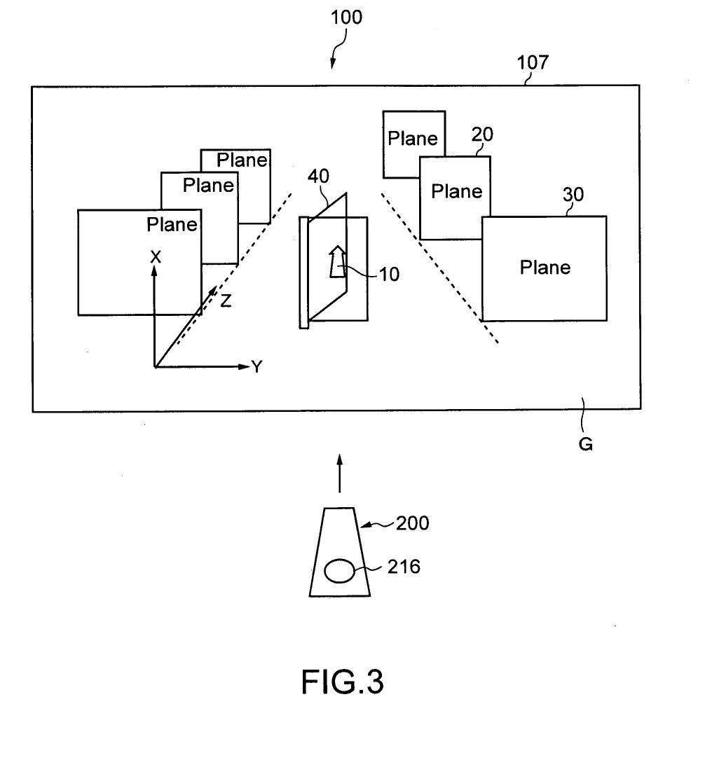

The user interface 206 includes a button or touch panel (hereinafter, referred to as detection start button) 216 (see FIG. 3) for notifying a start of an operation of the amplitude detection circuit 203 for detecting a movement in the depth direction (Z-axis direction). The user interface 206 also includes buttons, a touch panel, or a trackball (all of which are not shown) through which the movement of the pointer on the X-Y plane is input by the user. Information used for operating the pointer in the X-Y directions on the display screen is input through the buttons, touch panel, or trackball described above.

The modulation circuit 207 modulates the movement direction and the movement amount calculated by the CPU 204 and the information input by the user interface 206, and transmits the modulated information to the infrared ray-emitter 208. The infrared ray-emitter 208 emits infrared rays to the infrared ray-optical receiver 104 to transmit the information signal.

Next, a description will be given on an operation carried out when operating the pointer on the display screen in the depth direction.

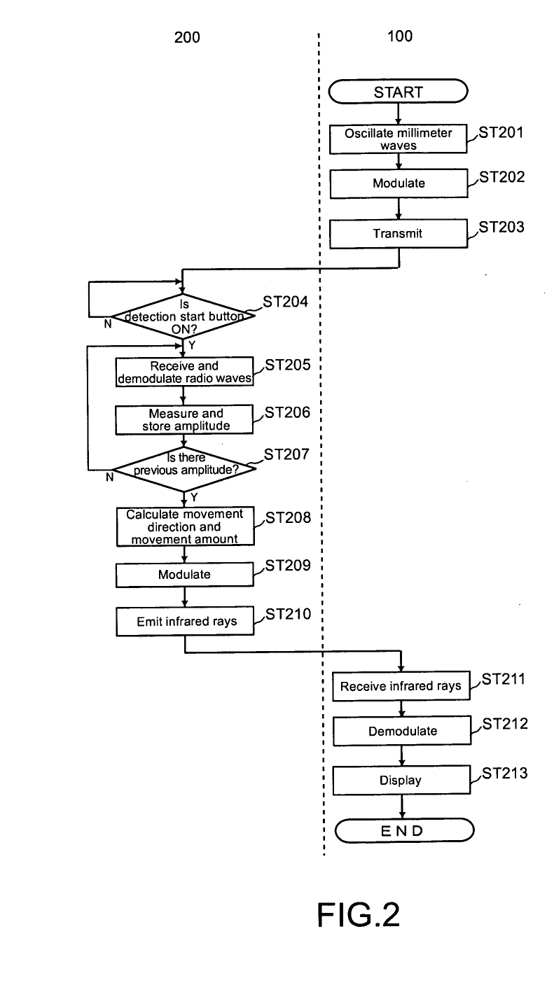

FIG. 2 is a flowchart of the operation.

First, the oscillator 101 of the information processing apparatus 100 oscillates millimeter waves (ST 201). The signal of the millimeter waves transmitted from the oscillator 101 is input to the modulation circuit 102 to be modulated (ST 202), and is transmitted from the antenna 103 thereafter (ST 203).

The pointing device for 3-dimensional operations 200 judges whether the detection start button 216 (see FIG. 3), for example, has been pressed (ST 204), and when the button is pressed, receives the radio waves through the antenna 201 and demodulates the radio waves by the demodulation circuit 202 (ST 205). After that, the amplitude of the demodulated signal is measured by the amplitude detection circuit 203 and is stored in the memory 205(ST 206).

Subsequently, judgment is made on whether a previous amplitude is stored in the memory 205 (ST 207), and when not stored, returns to Step 205 to measure the amplitude at a predetermined time interval and stores the value in the memory 205 (ST 206).

When the previous amplitude is stored in the memory 205, the movement direction of the pointer on the display screen in the depth direction (Z-axis direction) is calculated based on, for example, a magnitude correlation between the previous amplitude and the currently-obtained amplitude, and the movement amount thereof in the Z-axis direction is calculated based on a difference between the previous amplitude and the currently-obtained amplitude (ST 208).

Next, information on the calculated movement direction and movement amount is modulated by the modulation circuit 207 (ST 209), and the infrared ray-emitter 208 transmits the modulated signal through infrared rays 302 (ST 210). At this time, information on the X-Y plane input by the user interface 206 is also modulated for output.

After that, the infrared ray-optical receiver 104 of the information processing apparatus 100 receives the infrared rays (ST 211). After the infrared rays are demodulated by the demodulation circuit 105, the information signal transmitted from the pointing device for 3-dimensional operations 200 is processed by the CPU 106, and an operation signal thereof is then output to the display device 107 so that the pointer is displayed at an appropriate position.

As described above, according to this embodiment, it is possible to realize the oscillator 101 that oscillates millimeter waves by use of an inexpensive CMOS device, and detect the amplitude at high speed to thus calculate the movement amount and the movement direction of the pointing device for 3-dimensional operations 200 on the display screen in the depth direction (Z-axis direction). Specifically, although a distance d between the antennae 103 and 201 changes along with the movement of the pointing device for 3-dimensional operations 200 on the display screen in the Z-axis direction, it is possible to measure the amplitude of the radio waves corresponding to the distance d by the amplitude detection circuit 203 (ST 206), and control display of a pointer 10 (see FIG. 3) on the display screen in the depth direction in accordance with the change in amplitude of the radio waves. Because the pointer 10 is operated in the depth direction (Z-axis direction) on the display screen in accordance with the distance d between the antennae 103 and 201 (operation of the user in the depth direction), an operation that matches an intuitional operation of the user is realized.

Moreover, because the operation system 1 can be constituted by a single oscillator 101, modulation circuit 103, and antenna 103 and a single antenna 201, demodulation circuit 202, and amplitude detection circuit 203, it is possible to operate the pointer 10 on the display screen in the depth direction (Z-axis direction) with an extremely simple structure.

Furthermore, the operation does not rely on an absolute value of the amplitude since the pointing device for 3-dimensional operations 200 includes the memory 205 to enable detection of the movement amount and the like by obtaining a differential between an amplitude previously stored in the memory 205 and the currently-obtained amplitude. Similarly, the operation is hardly affected by fluctuations in angles of beams output by the antennae 103 and 201.

FIG. 3 is a diagram showing a state where a door displayed on the display screen is pressed by the pointing device for 3-dimensional operations 200.

As shown in FIG. 3, when a plurality of planes 20 and 30, a door 40, and the like are displayed on a display screen G in the depth direction (Z-axis direction), by positioning the pointer 10 on the door 40 and bringing the pointing device for 3-dimensional operations 200 closer to the display screen G in the depth direction (Z-axis direction), that is, by pressing the door 40, the distance d between antennae 103 and 201 (see FIG. 1) changes (i.e., becomes smaller). The amplitude of the radio waves corresponding to the distance d is measured by the amplitude detection circuit 203 (ST 206), and an information signal generated with regard to the movement amount and the movement direction is transmitted to the information processing apparatus 100. The information signal of the movement amount and the movement direction transmitted from the pointing device for 3-dimensional operations 200 is processed by the CPU 106, and an operation signal obtained by the processing is output to the display device 107, whereby display can be made such that the door 40 is opened. Because the operation of the pointer 10 on the display screen G in the depth direction (Z-axis direction) is carried out in accordance with the operation of the user of pressing the door 40 in the depth direction, an operation that matches an intuitional operation of the user can be realized when pressing the door 40 to open it.

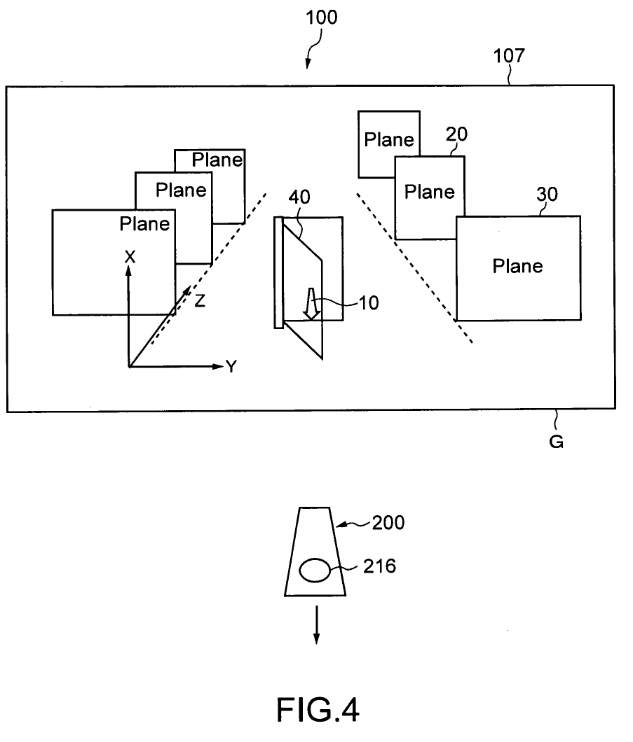

FIG. 4 is a diagram showing a state where the door 40 displayed on the display screen G is pulled by the pointing device for 3-dimensional operations 200.

As in FIG. 3, by positioning the pointer 10 on the door 40 and taking the pointing device for 3-dimensional operations 200 farther away from the display screen G in the depth direction (Z-axis direction), that is, by pulling the door 40, the distance d between the antennae 103 and 201 changes (i.e., becomes larger). The amplitude of the radio waves corresponding to the distance d is measured by the amplitude detection circuit 203 (ST 206), and an information signal generated with regard to the movement amount and the movement direction is transmitted to the information processing apparatus 100. The information signal of the movement amount and the movement direction transmitted from the pointing device for 3-dimensional operations 200 is processed by the CPU 106, and an operation signal obtained by the processing is output to the display device 107, whereby display can be made such that the door 40 is pulled. Because the operation of the pointer 10 on the display screen G in the depth direction (Z-axis direction) is carried out in accordance with the operation of the user of pulling the door 40 in the depth direction, an operation that matches an intuitional operation of the user can be realized when pulling the door 40.

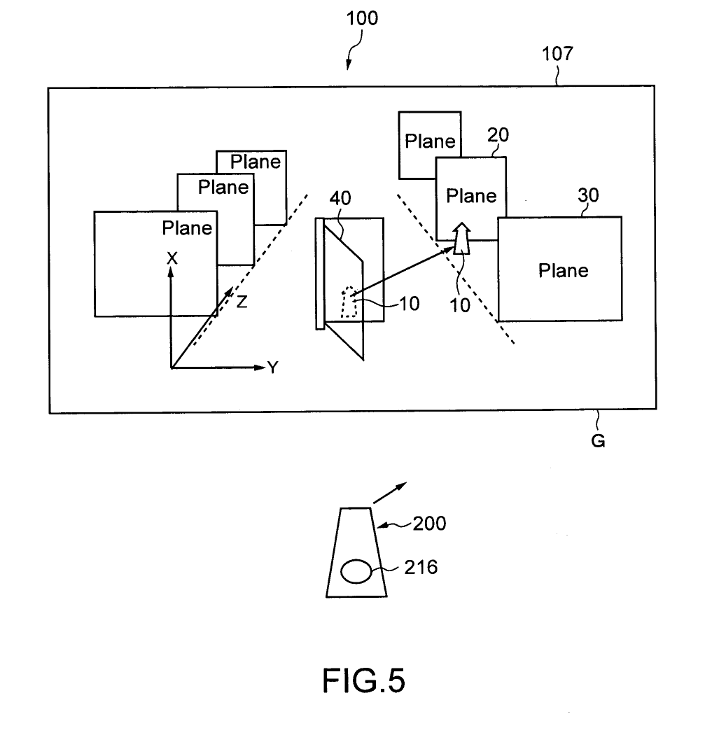

FIG. 5 is a diagram showing a state where the pointer 10 is moved to a different plane 20 on the display screen G by the pointing device for 3-dimensional operations 200.

By moving the pointing device for 3-dimensional operations 200 in the right-hand oblique direction toward the back from the state where the pointer 10 is positioned on the door 40, the distance d between the antennae 103 and 201 changes (i.e., becomes smaller). The amplitude of the radio waves corresponding to the distance d is measured by the amplitude detection circuit 203 (ST 206), and an information signal generated with regard to the movement amount and the movement direction is transmitted to the information processing apparatus 100. The information signal of the movement amount and the movement direction transmitted from the pointing device for 3-dimensional operations 200 is processed by the CPU 106, and an operation signal obtained by the processing is output to the display device 107, whereby display can be made such that the pointer 10 is displayed on the plane 20 placed further back than the door 40. Because the operation of the pointer 10 on the display screen G in the depth direction (Z-axis direction) is carried out in accordance with the operation of the user in the depth direction, an operation that matches an intuitional operation of the user can be realized when moving the pointer 10 from the plane 20 to another plane 20 or the like arranged at a different depth in the depth direction.

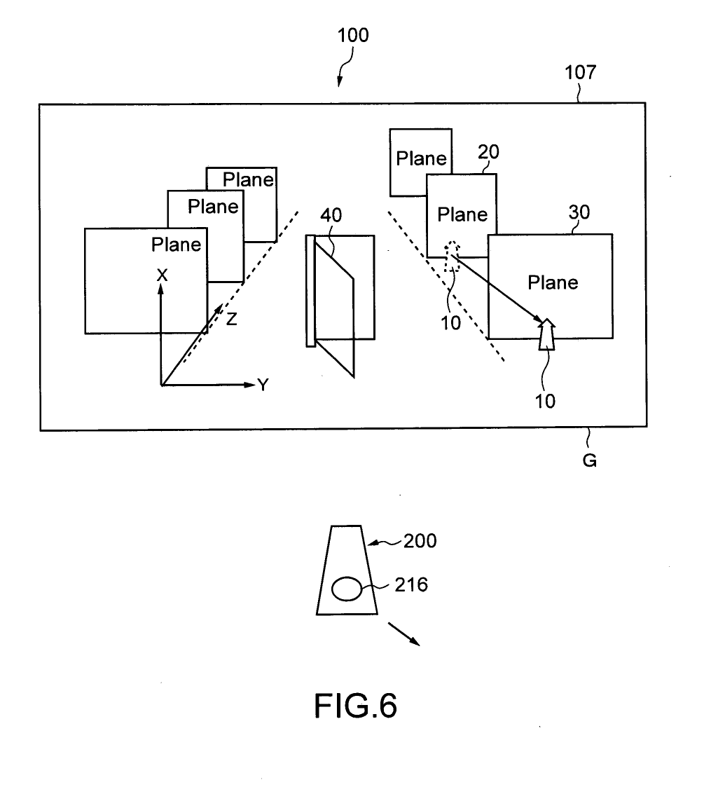

FIG. 6 is a diagram showing a state where the pointer 10 is moved to a different plane 30 on the display screen G by the pointing device for 3-dimensional operations 200.

By moving the pointing device for 3-dimensional operations 200 forward in the right-hand oblique direction from the state where the pointer 10 is positioned on the plane 20, the distance d between the antennae 103 and 201 changes (i.e., becomes larger). The amplitude of the radio waves corresponding to the distance d is measured by the amplitude detection circuit 203 (ST 206), and an information signal generated with regard to the movement amount and the movement direction is transmitted to the information processing apparatus 100. The information signal of the movement amount and the movement direction transmitted from the pointing device for 3-dimensional operations 200 is processed by the CPU 106, and an operation signal obtained by the processing is output to the display device 107, whereby display can be made such that the pointer 10 is displayed on the plane 30 placed more in the front than the plane 20. Because the operation of the pointer 10 on the display screen G in the depth direction (Z-axis direction) is carried out in accordance with the operation of the user in the depth direction, an operation that matches an intuitional operation of the user can be realized when moving the pointer 10 from the plane 20 to another plane 30 or the like arranged at a different depth in the depth direction.

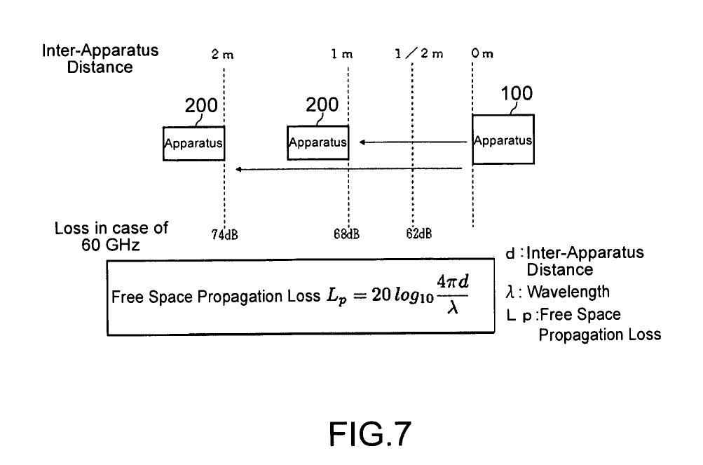

FIG. 7 is a diagram illustrating a relationship between a free space propagation loss and an inter-apparatus distance.

As shown in FIG. 7, a free space propagation loss (Lp decibel) of the radio waves can be expressed by Lp=20*log₁₀(4 nd/λ), where d represents an inter-antenna distance and λ represents a wavelength of the radio waves. For example, with the radio waves of 60 GHz, Lp is attenuated by 62 dB at the inter-apparatus distance of ½ m (50 cm). On the other hand, with the radio waves having a relatively low frequency used in related art, e.g., radio waves of 1 GHz, Lp is attenuated only by 26 dB at the same inter-apparatus distance of ½ m (50 cm), resulting in a difference of 36 dB, which is large. Thus, even when the apparatus is apart from other reflective objects by as small as ½ m (50 cm), with the radio waves of a millimeter wave, signals thereof are attenuated sufficiently. As a result, it is possible to suppress the problem of fluctuations of the amplitude caused by the effect of standing waves due to multipath in related art. Because millimeter waves have short wavelengths, antenna beams can be narrowed by an antenna of a practical size. Assuming that antenna efficiency is 55%, for example, an antenna gain (Ga) can be expressed by Ga=0.55*4πA/λ², where A represents an area of the antenna. Accordingly, the beams can be narrowed down to 10 dBi (3 dB half-value angle 55°) with an antenna of a 6 mm-square size at 60 GHz, for example. Therefore, the millimeter waves can suppress generation of multipath unnecessary for providing antenna directionality. Because millimeter waves have short wavelengths, resolution in judging a position of the antenna can be enhanced.

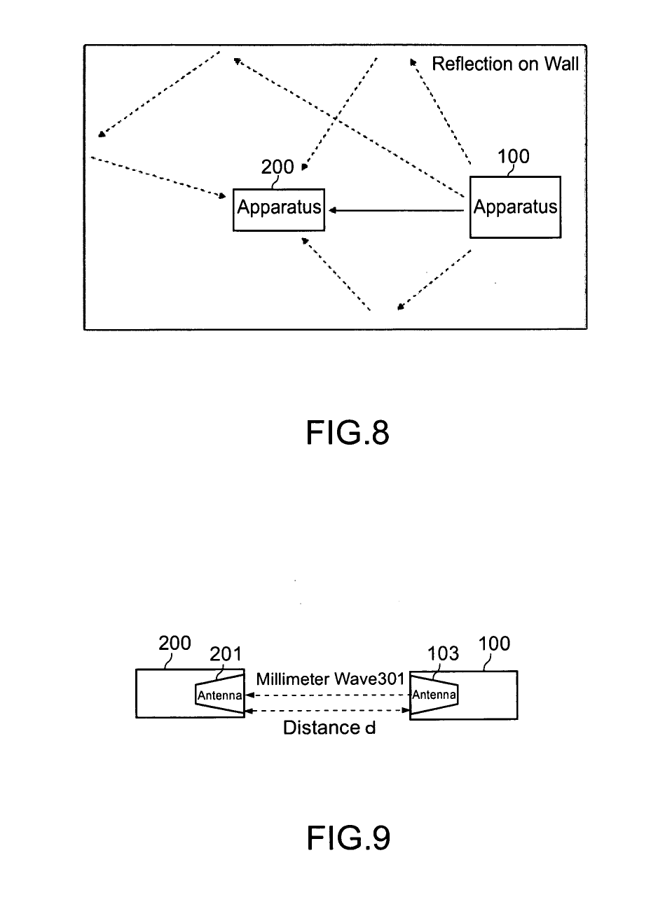

FIG. 8 is a diagram illustrating a problem of a frequency lower than the millimeter wave.

As shown in FIG. 8, when the frequency is lower than the millimeter wave, the free space propagation loss is small and standing waves are generated due to multipath, thereby complicating the distance judgment merely by means of the amplitude as in this embodiment. Moreover, the long wavelength obscures measurement points of the apparatuses. Furthermore, the long wavelength makes it hard to provide directionality to the antennae. This embodiment thus uses the millimeter waves. Because the millimeter waves have short wavelengths, the position of the transmission/reception antennae can be obtained with high accuracy. Further, because the millimeter waves cause large free space propagation loss, reflected waves affect little and measurement is less degraded by the standing waves. Therefore, it is possible to accurately obtain the distance between the apparatuses.

FIG. 9 is a setup diagram when actually conducting a propagation experiment at a millimeter wave (60 GHz).

The information processing apparatus 100 and the pointing device for 3-dimensional operations 200 are brought apart by the distance d, and millimeter waves of 60 GHz, for example, are transmitted from the information processing apparatus 100. An absolute gain of the antenna 103 is assumed to be 10 or 20 dBi, an absolute gain of the antenna 201, 15 dBi, and output power of the information processing apparatus 100, 10 dBm.

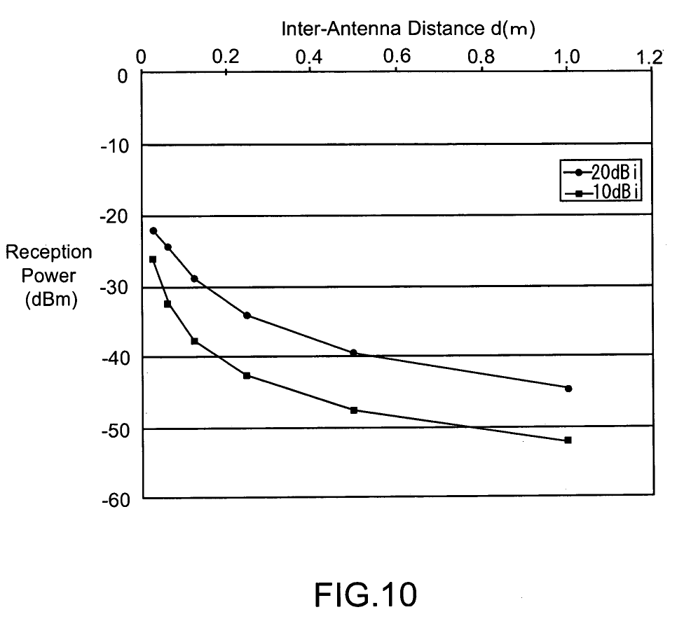

FIG. 10 shows a result of the experiment shown in FIG. 9.

It can be seen that there is a correlation between the inter-antenna distance d (m) and reception power (dBm) on the pointing device for 3-dimensional operations 200 side. The movement of the pointing device for 3-dimensional operations 200 can be read from the correlation between the inter-antenna distance d (m) and the reception power (dBm).

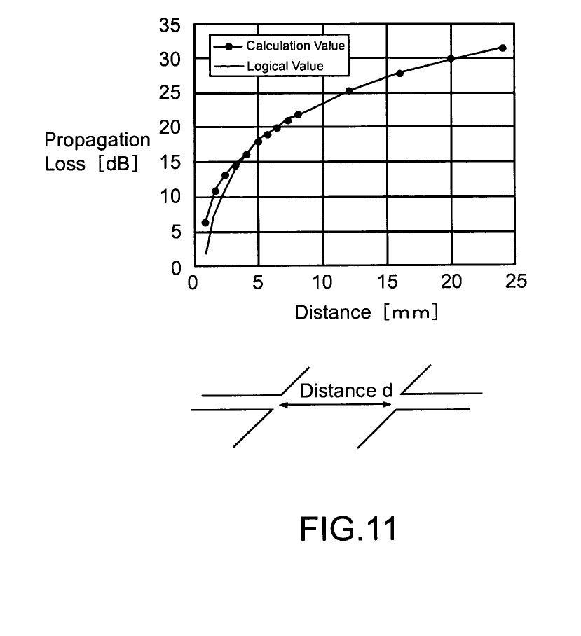

FIG. 11 shows a result of a simulation conducted to confirm how close transmission/reception antennae can be brought to each other.

A dipole antenna (Simulator micro-stripes) whose dipole length is 2.4 mm (=λ/2) is used. A logical value and a calculation value are substantially the same until reaching the distance of about 3 mm.

Next, a description will be given on another embodiment of the present invention.

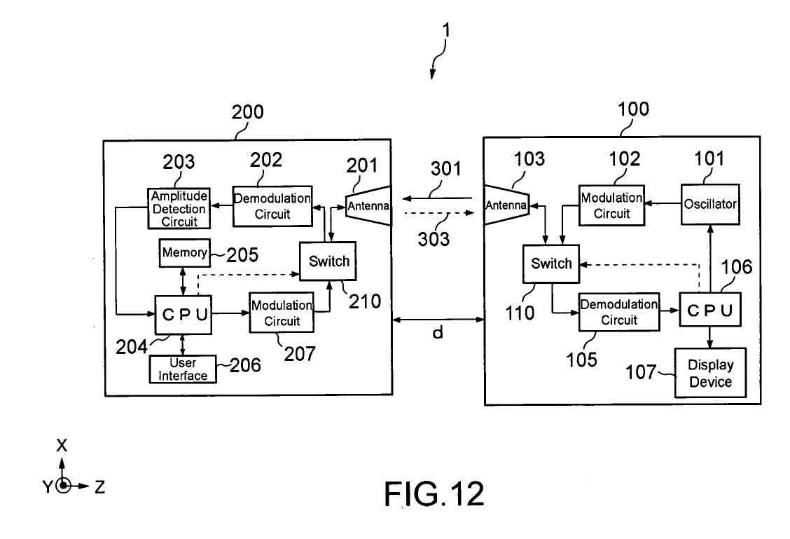

FIG. 12 is a block diagram showing a structure of the operation system when transmission of an information signal returned from the pointing device for 3-dimensional operations 200 is carried out using millimeter waves instead of infrared rays.

This embodiment is different from that shown in FIG. 1 in that the information processing apparatus 100 includes a switch 110 and is not provided with the infrared ray-optical receiver 104 shown in FIG. 1.

The switch 110 makes a switch between a “modulation circuit 102-antenna 103” connection and a “demodulation circuit 105-antenna 103” connection every time a predetermined time passes, in response to the control signal from the CPU 106.

The pointing device for 3-dimensional operations 200 is different from that shown in FIG. 1 in the point of including a switch 210 and not being provided with the infrared ray-emitter 208 shown in FIG. 1.

The switch 210 makes a switch between a “modulation circuit 207-antenna 201” connection and a “demodulation circuit 202-antenna 201” connection every time a predetermined time passes, in response to the control signal from the CPU 204.

In this case, it is also possible to bi-directionally exchange various types of data by time division using the millimeter waves 303. For example, it is possible to transmit/receive information on the movement direction of the pointer 10 on the display screen G in the depth direction (Z-axis direction) and movement amount thereof in the Z-axis direction and transmit/receive information on the movement amount of the pointer 10 regarding the X-Y plane, which is different from the information thereof in the Z-axis direction, individually.

Next, a description will be given on another embodiment of the present invention.

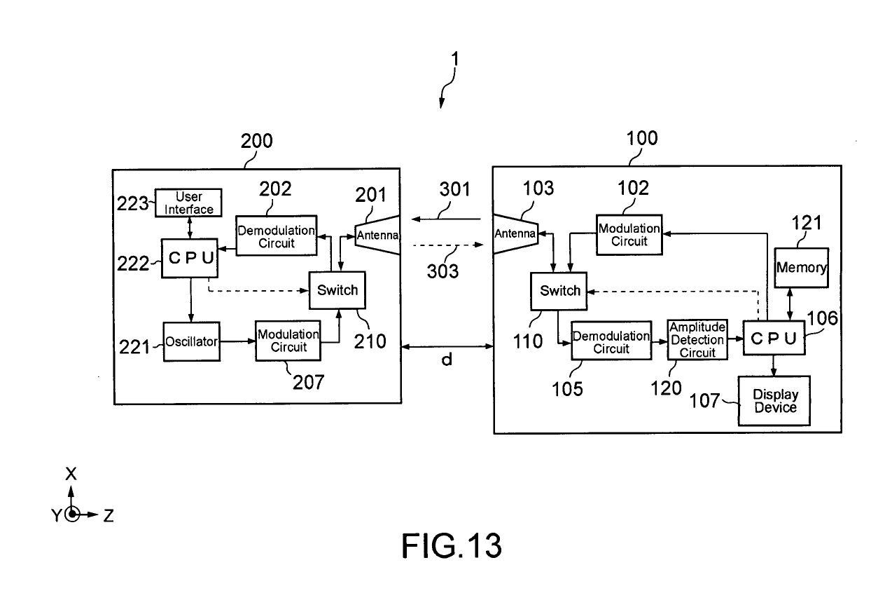

FIG. 13 is a block diagram showing a structure of the operation system when transmitting a reference signal of the millimeter wave 303 from the pointing device for 3-dimensional operations 200 side.

This embodiment is different from that shown in FIG. 12 in that the information processing apparatus 100 includes an amplitude detection circuit 120 and a memory 121 and is not provided with the oscillator 101. The amplitude detection circuit 120 is disposed between the demodulation circuit 105 and the CPU 106 and is structured to detect an amplitude of a signal demodulated by the demodulation circuit 105. The memory 121 is structured to store the amplitude every time a predetermined time passes, based on an instruction of the CPU 106.

The pointing device for 3-dimensional operations 200 is different from that shown in FIG. 12 in the point of including an oscillator 221, a CPU 222, and a user interface 223 and not being provided with the amplitude detection circuit 203, the CPU 204, the memory 205, and the user interface 206 shown in FIG. 12.

The oscillator 221 oscillates a signal of a millimeter wave to the modulation circuit 207, and the CPU 222 transmits to the switch 210 a signal for making a switch between the “demodulation circuit 202-antenna 201” connection and the “modulation circuit 207-antenna 201” connection. The user interface 223 is the same as the user interface 206.

As described above, it is possible to construct a similar system even when the oscillation of the millimeter waves is carried out in the pointing device for 3-dimensional operations 200.

As a modification of this embodiment, there may be employed a system in which the memory is provided on the pointing device for 3-dimensional operations 200 side so that information on the amplitude detected in the information processing apparatus 100 can be transmitted to the pointing device for 3-dimensional operations 200 using an information transmission path for the millimeter waves 301.

It should be noted that the present invention is not limited to the above embodiments, and various modifications may be made within a technical idea of the present invention.

For example, in the above embodiments, the pointing device for 3-dimensional operations 200 transmits information to the information processing apparatus 100 by radio using infrared rays. However, the present invention is not limited thereto and UHF (Ultra-High Frequency) or microwaves may be used instead, for example.

Moreover, in the above embodiments, the amplitude of the millimeter waves may be detected by simply calculating average power, or may be detected by generating a specific pattern and taking a correlation regarding the pattern on a reception side.

Further, the above embodiments use radio waves of a millimeter wave. Thus, because a desired directionality can be realized with a small antenna, the embodiments of the present invention can be applied to other portable apparatuses.

Furthermore, because the pointer 10 can be easily operated in the Z-axis direction as described above, it is possible to realize a variety of user interfaces.

What is claimed is:

1. An operation system used for operating a pointer on a display screen, comprising:
a first transmitting section configured to transmit radio waves of a millimeter band;
a first receiving section configured to receive the radio waves transmitted from the first transmitting section, a distance between the first transmitting section and the first receiving section being changeable;
a measuring section configured to measure an amplitude of the radio waves received by the first receiving section; and
an outputting section configured to output an operation signal for executing an operation of the pointer on the display screen in a depth direction in accordance with a change of the amplitude of the radio waves measured by the measuring section.

2. The operation system according to claim 1, comprising:
a first apparatus including a display device configured to display the display screen; and
a second apparatus as a pointing device for 3-dimensional operations for the first apparatus,
wherein the first apparatus includes the first transmitting section, a second receiving section configured to receive an information signal transmitted from the second apparatus, and the outputting section, and
wherein the second apparatus includes the first receiving section, the measuring section, an information generating section configured to generate information corresponding to the change of the amplitude of the radio waves measured by the measuring section, and a second transmitting section configured to transmit an information signal containing information generated by the information generating section.

3. The operation system according to claim 2,
wherein the information generating section compares data on the amplitude of the radio waves measured by the measuring section stored in a memory, which is configured to store pieces of data on amplitudes of radio waves measured by the measuring section, with data previously stored in the memory, and generates the information containing a movement direction and a movement amount of the pointer on the display screen in the depth direction based on a result of the comparison.

4. The operation system according to claim 2,
wherein the second apparatus includes a user interface section to which information for operating the pointer on the display screen in X-Y directions is input,
wherein the second transmitting section incorporates information input by the user interface section into the information signal and transmits the information signal thereafter, and
wherein the outputting section outputs as the operation signal a signal for executing the operation of the pointer on the display screen in the X-Y directions in accordance with the information input by the user interface section and contained in the information signal.

5. The operation system according to claim 1, comprising:
a first apparatus including a display device configured to display the display screen; and
a second apparatus as a pointing device for 3-dimensional operations for the first apparatus,
wherein the first apparatus includes the first receiving section, the measuring section, and the outputting section, and
wherein the second apparatus includes the first transmitting section.

6. The operation system according to claim 2,
wherein transmission/reception of the information signal is carried out by use of infrared rays between the second transmitting section and the second receiving section.

7. The operation system according to claim 2,
wherein transmission/reception of the information signal is carried out by use of the radio waves of the millimeter band between the second transmitting section and the second receiving section.

8. A pointing device for 3-dimensional operations used for operating a pointer on a display screen, comprising:
a receiving section configured to receive radio waves of a millimeter band;
a measuring section configured to measure an amplitude of the radio waves received by the receiving section;
an information generating section configured to generate information for executing an operation of the pointer on the display screen in a depth direction in accordance with a change of the amplitude of the radio waves measured by the measuring section; and
a transmitting section configured to transmit an information signal containing information generated by the information generating section.

9. A method of operating a pointer on a display screen, comprising:
transmitting radio waves of a millimeter band;
receiving the transmitted radio waves at a second position different from a first position at which the radio waves of the millimeter band are transmitted, a distance between the first position and the second position being changeable;
measuring an amplitude of the received radio waves; and
executing an operation of the pointer on the display screen in a depth direction in accordance with a change of the measured amplitude of the radio waves.
